(19) United States
(12) Patent Application Publication
(10) Pub. No.: US 2026/0184475 A1
(43) Pub. Date: Jul. 2, 2026

(54) SEALING COVER AND CONTAINER DEVICE HAVING THE SAME

(71) Applicants: FREE-FREE(USA) INC, Rancho Cucamonga, CA (US); FREE-FREE INDUSTRIAL CORP., Taipei City (TW)

(72) Inventor: Chien-Hua LIAO, Taipei City (TW)

(21) Appl. No.: 18/567,326

(22) PCT Filed: Sep. 28, 2023
(86) PCT No.: PCT/US23/33911

§ 371 Date: Dec. 5, 2023

(51) Int. Cl. B65D 45/34; A47J 47/02

(52) U.S. Cl. CPC B65D 45/34; A47J 47/02

(57) ABSTRACT

A sealing cover includes a lower cover, an upper cover and a trigger. The upper cover has an accommodating space, an abutting surface disposed on a side in the accommodating space, and a press switch installed on the other side in the accommodating space; the lower cover has a linkage seat, the linkage seat at least has an arm disposed protrusively, a pivot hole formed on the protruding arm, a sealing ring sheathing the lower cover; and the trigger is situated on the accommodating space, an end of the trigger is provided with a pivot, and the other end of the trigger is provided with a buckle, the pivot is pivotally mounted to the pivot hole, the buckle is disposed corresponding to the press switch, and the trigger further includes a protrusion disposed near the pivot and protruding substantially in the same direction with the buckle.

### CROSS-REFERENCE TO RELATED APPLICATION

This application is the National Phase of PCT International Application No. PCT/US2023/033911 filed on Sep. 28, 2023. The entire disclosures of the above application are all incorporated herein by reference.

### BACKGROUND OF THE DISCLOSURE

### Technical Field

The technical field relates to a container device, and more particularly relates to a sealing cover and a container device with the sealing cover.

### Description of Related Art

In our daily life, there is often a need for sealing something in order to achieve the purpose of maintaining freshness or preserving the thing, such as leftover food. At present, most of the container devices used for maintaining freshness or preserving things are made by adding a sealing structure to a cover of the container device, so that the cover can be placed on the container device to achieve the sealing effect.

However, it is not always easy to pull the cover after sealing, thus making the use inconvenient and taking more effort to open the container device.

In view of the aforementioned drawbacks, this disclosure provides a reasonable design and a feasible solution to overcome the drawbacks of the prior art.

### SUMMARY OF THE DISCLOSURE

It is a primary objective of this disclosure to provide a sealing cover and a container device having the same to facilitate opening or sealing the container device through a simple operation.

To achieve the aforementioned objective, the present disclosure provides a sealing cover including a lower cover, an upper cover and a trigger; the upper cover includes an accommodating space, an abutting surface disposed on a side in the accommodating space, and a press switch installed on another side in the accommodating space; the lower cover is elastically and movably connected to the upper cover and capable of moving in an upward-downward direction relative to the upper cover, the lower cover includes a linkage seat with an arm disposed protrusively, the arm is formed with a pivot hole, and a sealing ring sheathes the lower cover; the trigger is disposed on the accommodating space, an end of the trigger is provided with a pivot, another end of the trigger is provided with a buckle, the pivot is pivotally mounted to the pivot hole, the buckle is disposed corresponding to the press switch, and the trigger further includes a protrusion disposed near the pivot and outwardly protruding in a direction substantially the same as the buckle; when the trigger covers the accommodating space, the buckle is buckled to the press switch, so that the protrusion abuts against the abutting surface to lift the linkage seat together with the lower cover toward the upper cover; when the press switch releases the buckle, the trigger flips up by the pivot acting as the axis of rotation, and the protrusion is detached from the abutting surface to push the lower cover away from the upper cover.

To achieve the aforementioned objective, the present disclosure provides a container device, including a sealing cover, and a box for being covered by the sealing cover; the sealing cover includes a lower cover, an upper cover and a trigger; the upper cover includes an accommodating space, an abutting surface disposed on a side in the accommodating space, and a press switch installed on another side in the accommodating space; the lower cover is elastically and movably connected to the upper cover and capable of moving in an upward-downward direction relative to the upper cover, the lower cover includes a linkage seat with an arm disposed protrusively, the arm is formed with a pivot hole, and a sealing ring sheathes the lower cover; the trigger is disposed on the accommodating space, an end of the trigger is provided with a pivot, another end of the trigger is provided with a buckle, the pivot is pivotally mounted to the pivot hole, the buckle is disposed corresponding to the press switch, and the trigger further includes a protrusion disposed near the pivot and outwardly protruding in a direction substantially the same as the buckle; when the trigger covers the accommodating space, the buckle is buckled to the press switch, so that the protrusion abuts against the abutting surface to lift the linkage seat together with the lower cover toward the upper cover; when the press switch releases the buckle, the trigger flips up by the pivot acting as the axis of rotation, and the protrusion is detached from the abutting surface to push the lower cover away from the upper cover.

### BRIEF DESCRIPTION OF THE DRAWINGS

FIG. 1 is a perspective view of the present disclosure;

FIG. 2 is an exploded view of a sealing cover of the present disclosure;

FIG. 3 is a partially cross-sectional view of the present disclosure;

FIG. 4 is another cross-sectional view of a sealing cover of the present disclosure;

FIG. 5 is a further cross-sectional view of a sealing cover of the present disclosure;

FIG. 6 is a schematic view showing the operation of the present disclosure;

FIG. 7 is another schematic view showing the operation of the present disclosure;

FIG. 8 is a further schematic view showing the operation of the present disclosure; and

FIG. 9 is a perspective view of a sealing cover of the present disclosure in an open status.

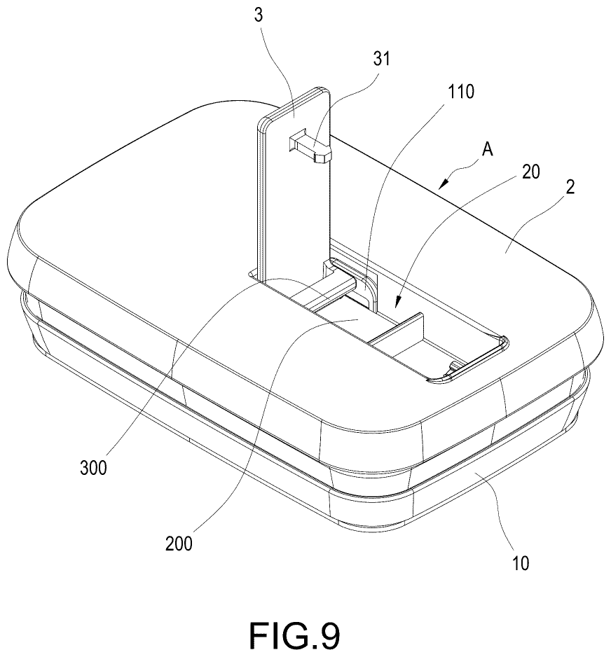

### DETAILED DESCRIPTION

The features and technical contents of the present disclosure will become apparent from the following detailed description taken with the accompanying drawing. It is intended that the embodiments and drawing disclosed herein are to be considered illustrative rather than restrictive.

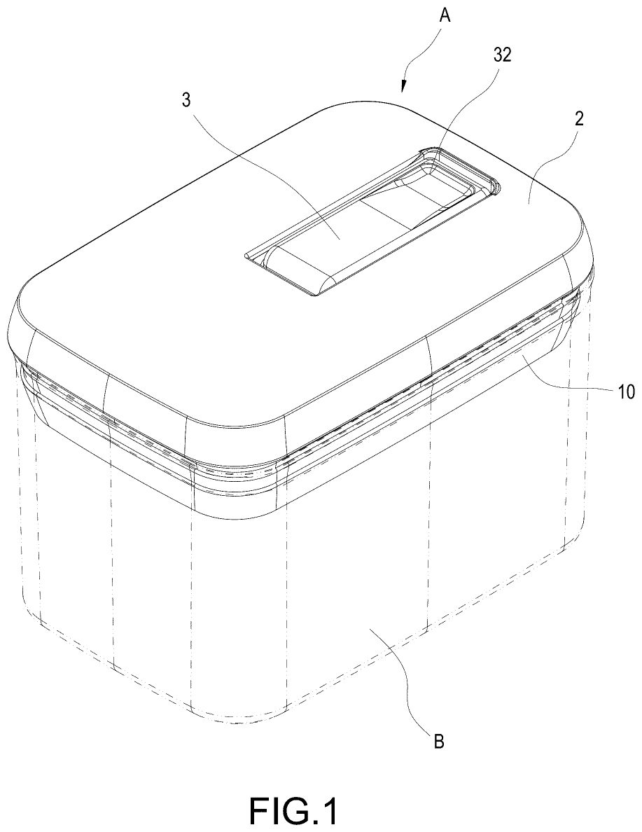

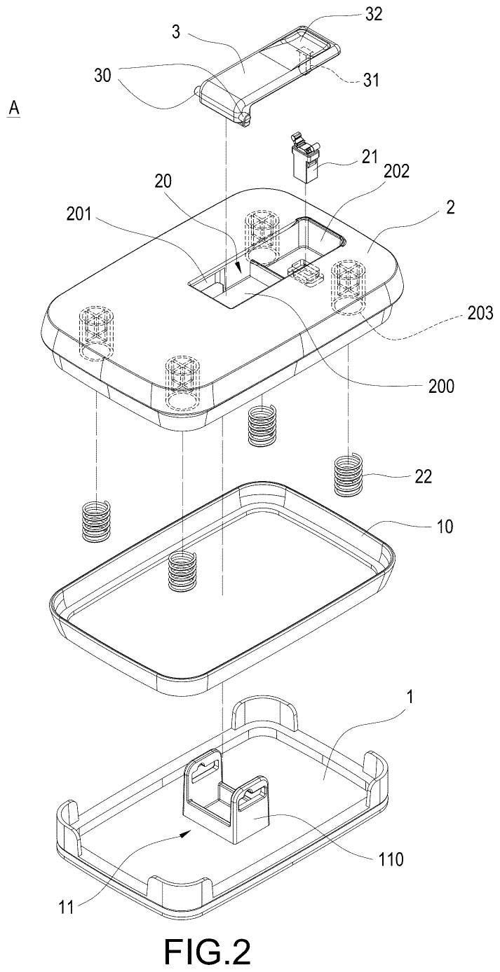

With reference to FIGS. 1 and 2 for the perspective view of the present disclosure and the exploded view of a sealing cover of the present disclosure respectively, the present disclosure provides a sealing cover and a container device, and the container device includes the sealing cover A, and a box B provided to be covered by the sealing cover A.

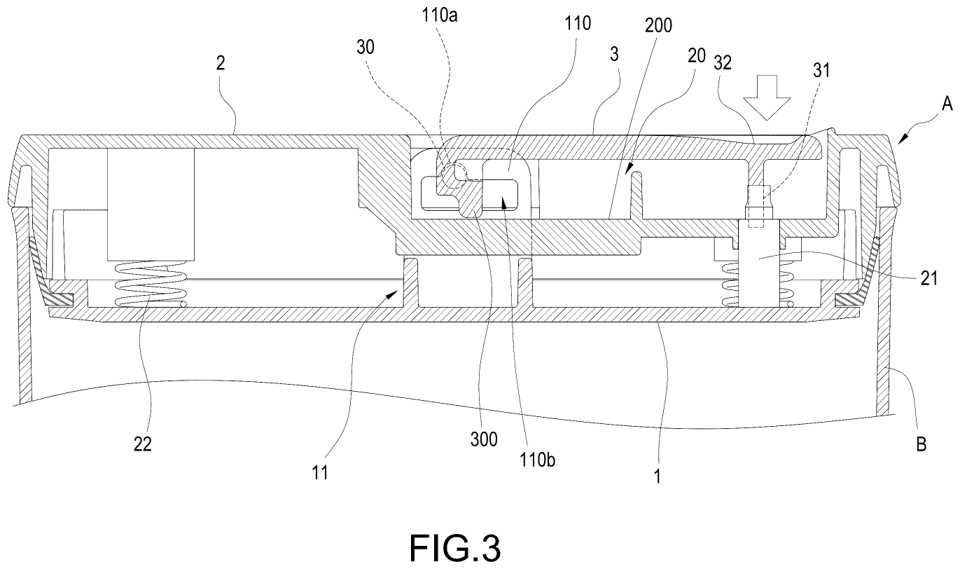

The sealing cover A is provided for covering the box B, and includes a lower cover 1, an upper cover 2 and a trigger 3, and a sealing ring 10 sheathing the lower cover. The sealing ring 10 is downward tapered, so that when the sealing ring 10 is provided for the sealing cover A to cover the box B, a sealing effect is achieved by the airtight contact between the sealing ring 10 and the box B (as shown in FIG. 3).

The upper cover 2 includes an accommodating space 20, an abutting surface 200 and at least one movable slot 201 disposed on a side in the accommodating space 20, a mounting slot 202 formed on another side of the accommodating space 20, and a press switch 21 installed in the mounting slot 202. In addition, the upper cover 2 and the lower cover 1 are elastically and movably connected, such that the upper cover 2 and the lower cover 1 move in an upward-downward direction relative to each other. In a specific embodiment, at least one elastic element 22 is installed between the upper cover 2 and the lower cover 1, the elastic element 22 is a compression spring, and the upper cover 2 includes at least one socket 203 formed on a side opposite to the lower cover 1 and provided for the elastic element 22 to be positioned in the socket 203 and abutted toward the lower cover 1 for a connection.

With reference to FIG. 3, the lower cover 1 includes a linkage seat 11 disposed thereon, the linkage seat 11 at least includes an arm 110 disposed protrusively, and the arm 110 includes a pivot hole 110a and a sunken hole 110b extending from the bottom of the pivot hole 110a, and the arm 110 is protrudes to the bottom of the upper cover 2, such that the pivot hole 110a and the sunken hole 110b are disposed relative to a side of the movable slot 201, and provided for passing an end of the trigger 3a through the movable slot 201 and pivotally mounting to the pivot hole 110a. In FIG. 2, an end of the trigger 3a is provided with a pivot 30, and another end of the trigger 3a is provided with a buckle 31, a surface of the back of the trigger 3 facing the buckle 31 is provided with a press part 32 in a concave manner, and the pivot 30 is a protruding shaft protruding from two sides of the trigger 3 separately or a shaft rod fixed to an end of the trigger 3 (not shown in the figures), which passes through the movable slot 201 and is pivotally mounted to the pivot hole 110a. The sunken hole 110b is provided for facilitating the alignment of the pivot 30 with the pivot hole 110a. In FIG. 3, the trigger 3 further includes a protrusion 300 disposed near the pivot 30 and protruding substantially in the same direction with the buckle 31, the protrusion 300 of an embodiment is integrally formed by extending the pivot 30 in the axial direction, or formed only by protruding the two sides of the pivot 30. In a specific embodiment, the protrusion 300 is disposed along the radial direction on a side of the pivot 30.

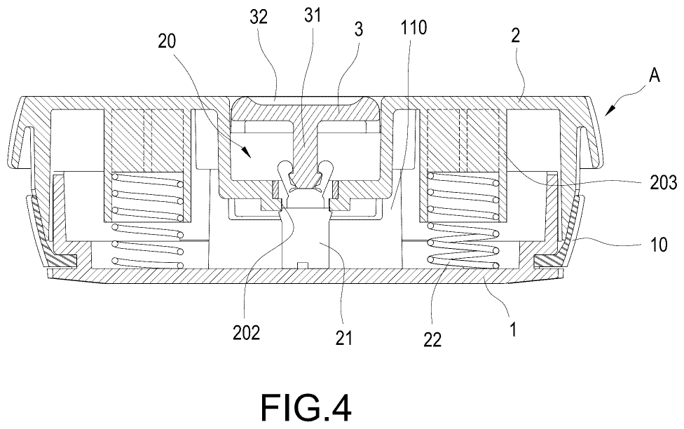

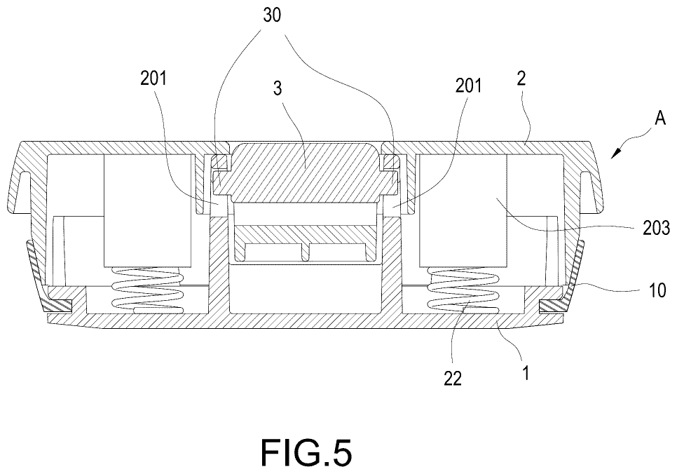

In FIGS. 3 to 5, when the trigger 3 covers the accommodating space 20, the buckle 31 of the trigger 3 is precisely buckled to the press switch 21(as shown in FIG. 4) and provided for abutting the protrusion 300 of the trigger 3 against the abutting surface 200 in the accommodating space 20, and the pivot 30 of the trigger 3 is situated in the pivot hole 110a (as shown in FIG. 5) to lift up the linkage seat 11 together with the lower cover 1, so that the lower cover 1 compresses each elastic element 22 to move toward the upper cover 2, and the sealing ring 10 outside the lower cover 1 seals the inner surface of the opening of the box B (as shown in FIG. 3). In this way, the sealing cover A covers onto the box B to achieve the sealing effect.

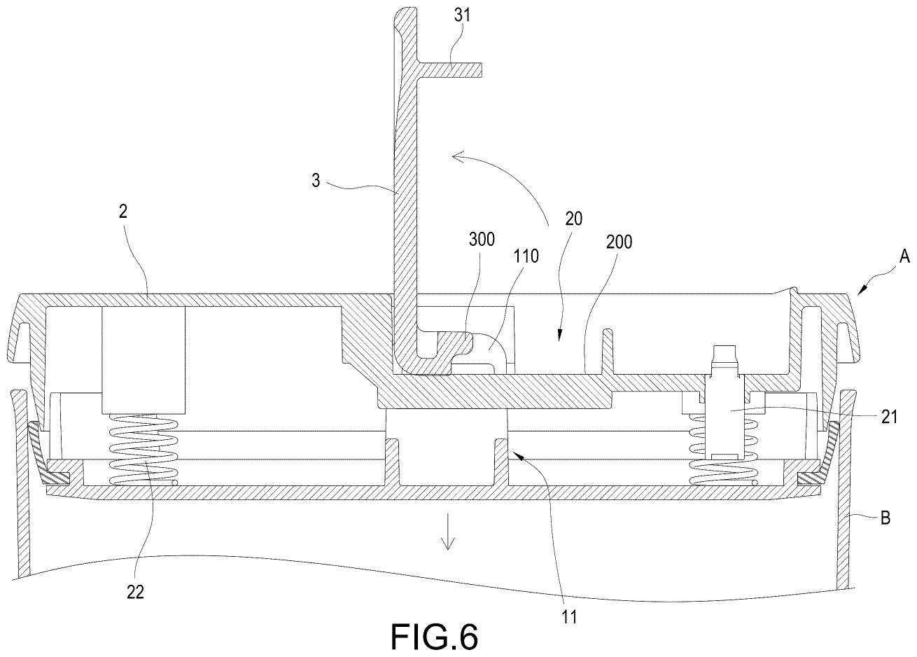

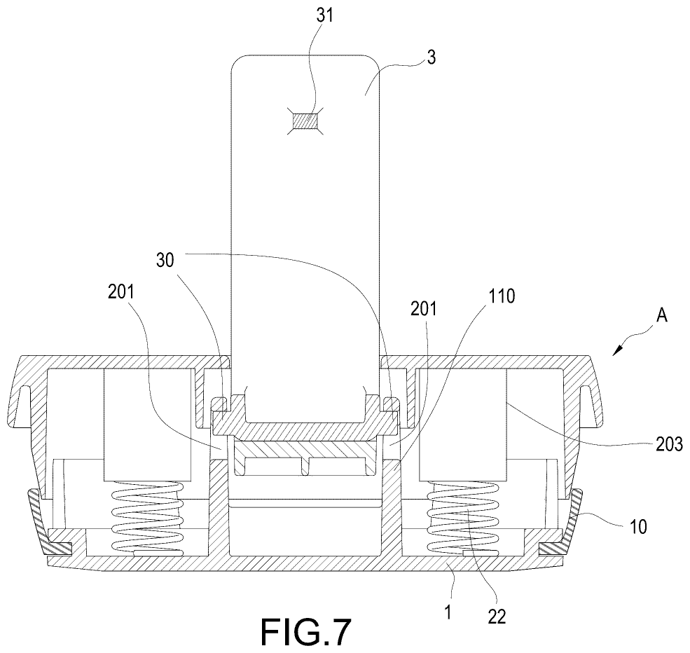

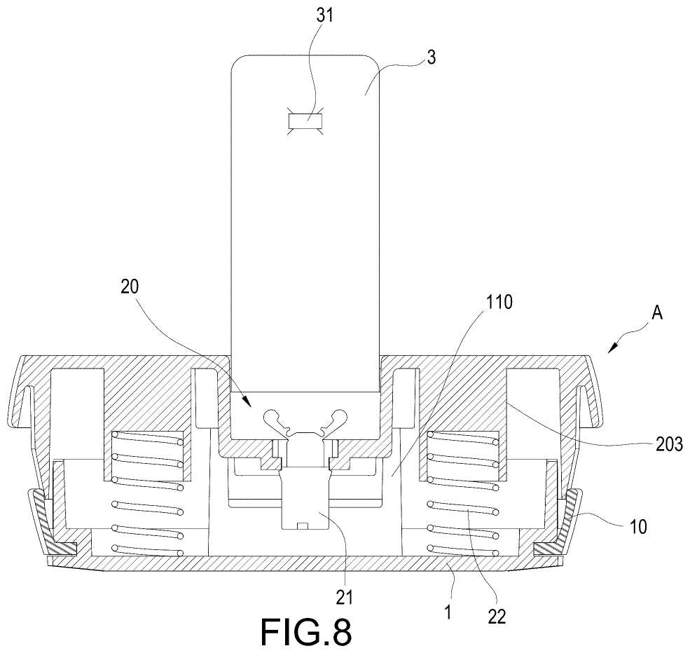

In FIG. 3, and 6 to 9, when a user wants to open the container device, the user only needs to press a press part 32 of the trigger 3 (as shown in FIG. 3), so that the buckle 31 of the trigger 3 is released by the press switch 21 (as shown in FIG. 8), and then flips up the trigger 3 using the pivot 30 as the axis of rotation. At this time, the protrusion 300 of the trigger 3 is detached from the abutting surface 200, and each elastic element 22 pushes down the lower cover 1 (as shown in FIGS. 6 and 7), so that the sealing ring 10 of the lower cover 1 is detached from the inner surface of the opening of the box B to remove the sealing cover A from the box cover B and open the box B.

Therefore, the aforementioned structures and assembly constitute the sealing cover and container device of the present disclosure.

While this disclosure has been described by means of specific embodiments, numerous modifications and variations could be made thereto by those skilled in the art without departing from the scope and spirit of this disclosure set forth in the claims.

What is claimed is:

1. A sealing cover, comprising:
an upper cover, comprising an accommodating space, an abutting surface disposed on a side in the accommodating space, and a press switch installed on another side in the accommodating space;
a lower cover, elastically and movably coupled to the upper cover and configured to move in an upward-downward direction relative to the upper cover, comprising a linkage seat disposed thereon, the linkage seat comprising an arm disposed protrusively and a pivot hole defined on the arm, wherein the lower cover is sheathed with a sealing ring; and
a trigger, disposed on the accommodating space, comprising a pivot disposed on one end thereof and a buckle disposed on another end thereof, the pivot pivotally mounted to the pivot hole, the buckle disposed corresponding to the press switch, and the trigger further comprising a protrusion disposed near the pivot and protruding substantially in a same direction with the buckle;
wherein, when the trigger covers the accommodating space, the buckle is buckled to the press switch to make the protrusion abut against the abutting surface to lift the linkage seat together with the lower cover toward the upper cover;
when the press switch releases the buckle, the trigger flips up by the pivot acting as an axis of rotation, and the protrusion is detached from the abutting surface to push the lower cover away from the upper cover.

2. The sealing cover according to claim 1, wherein at least one movable slot is defined on one side of the accommodating space, and the pivot is pivotally mounted to the pivot hole through the movable slot.

3. The sealing cover according to claim 1, wherein a mounting slot is defined on one side of the accommodating space, and the press switch is installed in the mounting slot.

4. The sealing cover according to claim 1, wherein at least one elastic element installed between the upper cover and the lower cover.

5. The sealing cover according to claim 4, wherein the upper cover comprises at least one socket disposed on a side thereof facing the lower cover, and the elastic element is positioned in the socket and abuts against the lower cover.

6. The sealing cover according to claim 1, wherein the arm further comprises a sunken hole extended from a bottom of the pivot hole.

7. The sealing cover according to claim 1, wherein the sealing ring is downward tapered.

8. The sealing cover according to claim 1, wherein the pivot is a convex shaft protruding from two sides of the trigger, or the pivot is a shaft rod fixed to an end of the trigger.

9. The sealing cover according to claim 1, wherein the protrusion is integrally formed with the pivot along an axial direction of the pivot, or the protrusion is disposed protrusively from the two sides of the pivot separately.

10. A container device, comprising:
a box; and
a sealing cover, covering on the box, and further comprising:
an upper cover, comprising an accommodating space, an abutting surface disposed on a side in the accommodating space, and a press switch installed on another side of the accommodating space;
a lower cover, elastically and movably coupled to the upper cover, and configured to move in an upward-downward direction relative to the upper cover, comprising a linkage seat disposed thereon, the linkage seat comprising an arm disposed protrusively, a pivot hole defined on the arm, wherein a sealing ring sheathed on the lower cover; and
a trigger, disposed on the accommodating space, comprising a pivot disposed on one end thereof and a buckle disposed on another end thereof, the pivot pivotally mounted to the pivot hole, the buckle disposed corresponding to the press switch, and the trigger further comprising a protrusion disposed near the pivot and protruding substantially in a same direction with the buckle;
wherein, when the trigger covers the accommodating space, the buckle is buckled to the press switch to make the protrusion abut against the abutting surface to lift the linkage seat together with the lower cover toward the upper cover;
when the press switch releases the buckle, the trigger flips up by the pivot acting as an axis of rotation, and the protrusion is detached from the abutting surface to push the lower cover away from the upper cover.

11. The container device according to claim 10, wherein at least one movable slot is defined on one side of the accommodating space, and the pivot is pivotally mounted to the pivot hole through the movable slot.

12. The container device according to claim 10, wherein a mounting slot is defined on one side of the accommodating space, and the press switch is installed in the mounting slot.

13. The container device according to claim 10, wherein at least one elastic element installed between the upper cover and the lower cover.

14. The container device according to claim 13, wherein the upper cover comprises at least one socket disposed on a side thereof facing the lower cover, and the elastic element is positioned in the socket and abuts against the lower cover.

15. The container device according to claim 10, wherein the arm further comprises a sunken hole extended from a bottom of the pivot hole.

16. The container device according to claim 10, wherein the sealing ring is downwardly tapered.

17. The container device according to claim 10, wherein the pivot is a convex shaft protruding from two sides of the trigger, or the pivot is a shaft rod fixed to an end of the trigger.

18. The container device according to claim 10, wherein the protrusion is integrally formed with the pivot along an axial direction of the pivot, or the protrusion is disposed protrusively from the two sides of the pivot separately.
